(19) United States
(12) Patent Application Publication
(10) Pub. No.: US 2023/0353890 A1
(43) Pub. Date: Nov. 2, 2023

(54) MULTI-SPECTRAL LIGHT-FIELD DEVICE

(71) Applicant: CSEM Centre Suisse d'Electronique et de Microtechnique SA - Recherche et Développement, Neuchâtel (CH)

(72) Inventors: Christiane Gimkiewicz, Ismaning bei München (DE); Benjamin Gallinet, Pratteln (CH); Siavash Arjomand Bigdeli, Neuchâtel (CH); Georges Kotrotsios, Lausanne (CH)

(21) Appl. No.: 18/006,006

(22) PCT Filed: Jul. 20, 2020
(86) PCT No.: PCT/IB2020/056800

§ 371 Date: Jan. 19, 2023

(51) Int. Cl. H04N 23/957; H04N 23/10; G06V 10/77; G06V 10/143; H04N 23/55

(52) U.S. Cl. CPC H04N 23/957; H04N 23/10; G06V 10/77; G06V 10/143; H04N 23/55; G02B 5/28

(57) ABSTRACT

A multi-spectral light-field device, including an imaging component, arranged to image a light-field emitted by an object point of an object and for setting an input signal including a range of incidence angles on an optical filter. The optical filter has a transmission function depending on the incidence angles to transform the input signal into an output signal including a spectral distribution associated to an angular distribution. A micro-lens array is arranged to transform the spectral distribution of the output signal into a spatial distribution on an image plane. This multi-spectral light-field device is adapted to be integrated in a small, compact and/or handheld device, as a smartphone and also to deliver high resolution images. Also an imaging system which is a compact twin camera device. Also an object identification system allowing an image reconstruction in real-time on limited computational resources of a mobile device, by using a machine-learning module.

### TECHNICAL DOMAIN

The present invention concerns a multi-spectral light-field device. The present invention concerns also an imaging system comprising such a device and a system for object identification, in particular for moving object identification, comprising such a device.

### RELATED ART

Objet identification is useful in many applications as e.g. well-being, health, cosmetics, etc. The object of interest has a number of properties, as a shape, a color, a size, a surface texture, a material of which is made, etc. Light emanates from a point of an object (or “object point”) as a light-field containing a directional light distribution function, that is related to the object's reflection function.

A conventional camera captures only the reflected intensity of a single object point in a single pixel of its (two-dimensional) image sensor. Thus, the conventional camera accumulates the footprint of the object and a limited number of colours.

Light-field cameras are fragmenting the light-field of the object by a micro-lens array into mosaic images of varying view-points, in order to retrieve depth information and thus allow to determine further the object's size. Known light-field cameras are capable to portray the directional distribution of an object point.

In this context, a micro-lens array is an array of micro-lenses, i.e. an array of ultra-thin or very flat optical components, having an optic height in the order of few millimeters. The micro-lens array is connected, preferably directly connected, to an image sensor.

In this context, the optic height is the height (or the thickness) of the first surface of the first optical component to the image sensor it is cooperating with. In this context, a micro-optical component (or ultra-thin optical component or very flat optical component) is an optical component having an optic height in the order of few millimeters, e.g. 2 mm, 1 mm or smaller.

It is also known to explore the object's spectral content by using spectral or multi-spectral cameras. Common multi-spectral cameras deliver a three-dimensional intensity map without taking into account the light-field. The three-dimensional intensity map comprises intensity values per object point position and wavelength. The complete object is described within a spectro-spatial data cube. This data cube is often used to determine the object's material.

Besides the shape and the spectral information of an object point, there is another object property suitable to be detected: its type of reflection. The object reflection can vary in a range comprising among others a completely diffusive reflection (as in the case of a sand blasted metal surface), a complete specular reflection (as in the case of a polished metal mirror) and a non-symmetrical reflection (as in the case of an engraved metal foil). Such reflectance properties are connected to the object's surface property, which imprints a certain reflectance intensity function, e.g. the bi-directional reflectance distribution function (“BRDF”).

Spectral imaging based on light-field cameras (or multi-spectral light-field camera) should help to identify at least the object's shape, size, material and further the surface properties in one shot. Thus, they are an ideal candidate for object identification devices.

The document U59307127 describes a multi-spectral light-field camera comprising an imaging component (e.g. an imaging lens), a micro-lens array in the focal plane of this imaging lens, an image sensor in the back-focal plane of the micro-lens array and two different sets of color filter arrays. The first filter array is placed close to the stop plane of the imaging lens (i.e. near the diaphragm position of the imaging lens) and the second filter array is directly attached to the image sensor. The lights from an object pass through the respective filters of the first filter array and of the second filter array, to simultaneously form a plurality of object's spectral image types on an image plane of the image sensor. Large ray angles in the stop plane are typical for very small optical devices like smartphone cameras. In order to avoid vignetting, the first filter array has to provide spectral transmission for the complete spectrum. Thus, the used filters are bandpass filters providing only a broad spectral width. For a higher spectral resolution, the filter functions have to be more specific for the ray angles, too. Therefore, the described solution is complex as two filter arrays are used. Moreover, it is not adapted as such for having high spectral resolution when integrated in a handheld device as a smartphone.

The document EP2464952 describes a spectral light-field camera comprising a pin-hole as first imaging lens, like in a camera obscura. The “imaged” beams are passing a dispersive component (as a grating or a prism) and are relayed by a second lens towards a micro-lens array. An image sensor is placed into the back-focal plane of the micro-lens array. Due to the dispersive component, a continuous hyperspectral information of the object is available. The main drawback of this solution is the low light throughput for high-resolution results, since the light transmission is governed by the entrance pin-hole diameter, which is also determining the spectral resolution. Moreover, the beam path is long and therefore not suitable for very compact devices as a smartphone camera.

A disadvantage of light-field cameras is the computational effort for the image reconstruction. Recent attempts try to use machine-learning for this image reconstruction. The document US2019279051 describes a classification method based on deep learning for a (non-spectral) light-field camera. However and especially for a spectral light-field camera, the complexity of the data delivered may limit the potential of a full image reconstruction in real-time on the limited computational resources of a mobile device.

### SHORT DISCLOSURE OF THE INVENTION

An aim of the present invention is the provision of a multi-spectral light-field device that overcomes the shortcomings and limitations of the state of the art.

Another aim of the invention is the provision of a multi-spectral light-field device adapted to be integrated in a small, compact and/or handheld (mobile) device, as a smartphone.

Another aim of the invention is the provision of a multi-spectral light-field device adapted to deliver high resolution images.

An auxiliary aim of the invention is the provision of an object identification system allowing an image reconstruction in real-time on the limited computational resources of a mobile device.

According to the invention, these aims are attained by the object of the attached claims, and especially by the multi-spectral light-field device according to claim 1, whereas dependent claims deal with alternative and preferred embodiments of the invention.

The multi-spectral light-field device according to the invention comprises:
an imaging component, arranged to image at least a part of the light-field emitted by at least one object point of an object and for setting an input signal comprising a range of incidence angles on an optical filter;
this optical filter, having a transmission function depending on the incidence angles, so as to transform this input signal into an output signal, comprising a spectral distribution associated to an angular distribution;
a micro-lens array, arranged to transform this spectral distribution into a spatial distribution on an image plane.

In the context, the expression “spectral distribution” indicates a given amplitude or intensity, as a function of a wavelength and/or of a polarization.

In this context, the expression “angular distribution” indicates a given amplitude or intensity, as a function of the output angle.

In this context, the expression “spatial distribution” indicates a given amplitude or intensity, as a function of the position on the image plane.

The claimed optical filter associates a spectral distribution to an angular distribution, i.e. defines a function linking the spectral distribution to the angular distribution.

The optical filter of the device according to the invention is then placed between the optical component and the micro-lens array. It is arranged so as to filter the (indistinguishable) spectral content from the imaging component as a function of the incidence angle(s).

In other words, the optical filter is arranged so as to transform the input signal defined on a range of angles into an output signal comprising directional spectral or angular spectral contents, i.e. into a signal comprising angle-dependent spectral contents of the light-field. Those angle-dependent spectral contents are thus spatially distributed on an image plane by the micro-lens array. In one preferred embodiment, the device according to the invention comprises an image sensor in the image plane.

In one preferred embodiment, the filter comprises a substrate supporting one or more layers and/or one or more structures.

According to the invention, the optical filter is arranged so as to transmit to the micro-lens array the wavelengths of the received light rays in dependency of the angle of incidence (AOI) of the light rays on the optical filter. In other words, the optical filter according to the invention is arranged so as to transform an input signal defined on a range of angles and comprising an indistinguishable spectral content into an output signal comprising (different) spectral distributions for each angle of the angular distribution. Those (different) spectrally sorted distributions are then spatially separated on an image plane by the micro-lens array.

In other words, the claimed optical filter allows to create a wavelength dependent spatial distribution of the light-field on an image plane. The claimed optical filter is therefore an AOI-dependent filter, as its transmission profile or function depends on the light incidence angle.

Moreover, since the claimed optical filter associates a spectral distribution to an angular distribution, the claimed micro-lens array is arranged to transform this spectral distribution into a spatial distribution on the image plane. In other words, thanks to the presence of the claimed optical filter, the input signal for the claimed micro-lens array is not an angular distribution as in the state of the art, but a spectral distribution.

Thanks to the presence of a micro-lens array, the device according to the invention provides the advantage to also retrieve depth information, and thus to allow to determine further the object's size, as in light-field cameras. Thanks to the presence of the claimed optical filter, the device according to the invention provides the advantage to retrieve object's surface properties as well.

In other words, the invention provides the advantage to have a device which is at the same time a light-field device and a multi-spectral device, and which is more simple and compact than the known multi-spectral light-field devices, since the claimed multi-spectral light-field device comprises one optical filter. Therefore, the claimed multi-spectral light-field device can be easily integrated in a small, compact and/or handheld (mobile) device, as a smartphone.

The multi-spectral light-field device according to the invention is then capable to collect all relevant data of an object point in the field of view, comprising BRDF data, in a snap-shot.

In one preferred embodiment, the present invention concerns also an object identification system, comprising the multi-spectral light-field device according to the invention, and a machine-learning module connected to the multi-spectral light-field device, and arranged for identifying the object based on data collected by the multi-spectral light-field device.

In other words, a snap-shot of the multi-spectral light-field device of the invention is the input to a machine-learning module, whose output is the identified object and also (but not necessarily) its properties.

In one preferred embodiment, both the multi-spectral light-field device and the machine-learning module belong to a mobile device. Advantageously, the claimed system is therefore optimized for limited computational resources of this mobile device.

In one preferred embodiment, the machine-learning module is arranged for retrieving multi-spectral 3D-images out of multi-spectral light-field snap-shot images from the multi-spectral light-field device.

In one embodiment, the object identification system comprises:
a first machine-learning module for identifying an object by its shape,
a second machine-learning module for identifying spectral properties of the object,
the machine-learning module of the object identification system of the invention, being a third machine-learning module arranged for evaluating the separate results of the first machine-learning module and the second machine-learning module, so as to identify the object and its properties.

In one embodiment, the first machine-learning module, the second machine-learning module and the third machine-learning module are the same machine-learning module.

In another embodiment, any of the first machine-learning module, the second machine-learning module and the third machine-learning module are replaced with a hand designed (or hand crafted) algorithm.

### SHORT DESCRIPTION OF THE DRAWINGS

Exemplar embodiments of the invention are disclosed in the description and illustrated by the drawings in which:

FIG. 1 illustrates schematically an embodiment of a multi-spectral light-field device according to the invention.

FIG. 2 illustrates schematically another embodiment of a multi-spectral light-field device according to the invention, wherein the aperture of the imaging component is a large aperture, so as to ensure a transmittance of the wavelength λ₀ on all micro-lenses (via the corresponding angle of incidence on the filter θ₀=0°).

FIG. 3A illustrates the resonance wavelength (dispersion) versus the incidence angle (AOI) on the optical filter, in the embodiment in which the optical filter of the multi-spectral light-field device according to the invention is an interference filter.

FIG. 3B illustrates the resonance wavelength (dispersion) versus the incidence angle (AOI) on the optical filter, in the embodiment in which the optical filter of the multi-spectral light-field device according to the invention is a filter based on a waveguide with periodic corrugation.

FIG. 4A illustrates a cut view of an optical filter of the multi-spectral light-field device according to the invention, wherein the optical filter comprises a dispersive resonant waveguide grating.

FIG. 4B illustrates the transmission spectra of the filter of FIG. 4A, as a function of the wavelength and of the incidence angle.

FIG. 5A illustrates the full dispersion of the optical filter of FIG. 4A, i.e. the intensity for a wavelength of 508 nm, as a function of the polar θ and azimuthal ϕ incidence angles.

FIG. 5B illustrates the full dispersion of the optical filter of FIG. 4A, i.e. the intensity for a wavelength of 468 nm, as a function of the polar θ and azimuthal ϕ incidence angles.

FIG. 5C illustrates the full dispersion of the optical filter of FIG. 4A, i.e. the intensity for a wavelength of 586 nm, as a function of the polar θ and azimuthal ϕ incidence angles.

FIG. 5D illustrates the full dispersion of the optical filter of FIG. 4A, i.e. the intensity for a wavelength of 440 nm, as a function of the polar θ and azimuthal ϕ incidence angles.

FIG. 6A illustrates a cut view of an optical filter of the multi-spectral light-field device according to the invention, wherein the optical filter comprises an encapsulated dispersive plasmonic grating.

FIG. 6B illustrates the transmission spectra of the filter of FIG. 6A, as a function of the wavelength and of the incidence angle.

FIG. 6C illustrates schematically another embodiment of a multi-spectral light-field device according to the invention, comprising an encapsulated optical filter.

FIG. 7A illustrates a side view of an embodiment of an optical filter of a multi-spectral light-field device according to the invention, comprising two sub-zones with polarized response and placed orthogonally in order to build a system response that is independent of the incident light polarization.

FIG. 7B illustrates a top view of the optical filter of FIG. 7A.

FIG. 7C illustrates a top view of an arrangement of two optical filters of FIGS. 7A/7B.

FIG. 8 illustrates schematically another embodiment of a multi-spectral light-field device according to the invention, for two different object points OP1 and OP2.

FIG. 9 illustrates schematically another embodiment of a multi-spectral light-field device according to the invention, where the micro-lens array and the optical filter are processed on the image sensor.

FIG. 10 illustrates a cut view of an embodiment of the micro-lens array and of the image sensor of the multi-spectral light-field device according to the invention.

FIG. 11 illustrates schematically another embodiment of a multi-spectral light-field device according to the invention, with an optical filter having a step-wise change in the filter transmission function.

FIG. 12 illustrates schematically another embodiment of a multi-spectral light-field device according to the invention, with an optical filter having a gradient-wise change in the filter transmission function.

FIG. 13 illustrates the unpolarised transmission spectra of an optical filter comprising a dispersive resonant waveguide grating, as a function of the wavelength and of the incidence angle.

FIG. 14A illustrates a cut view of an embodiment of an optical filter of a multi-spectral light-field device according to the invention, arranged on a curved substrate, so as to enlarge the spectral range of the multi-spectral light-field device.

FIG. 14B illustrates a cut view of an embodiment of an optical filter of a multi-spectral light-field device according to the invention, directly arranged on the imaging component, so as to enlarge the spectral range of the multi-spectral light-field device and to increase the compactness and robustness.

FIG. 15 illustrates schematically an embodiment of the imaging system according to the invention.

FIG. 16 illustrates schematically another embodiment of the imaging system according to the invention.

FIG. 17 illustrates a flow-chart for an object identification system based on an imaging system according to the invention, allowing separated object identification tasks in both hardware and software, for faster machine-learning based object identification.

### EXAMPLES OF EMBODIMENTS OF THE PRESENT INVENTION

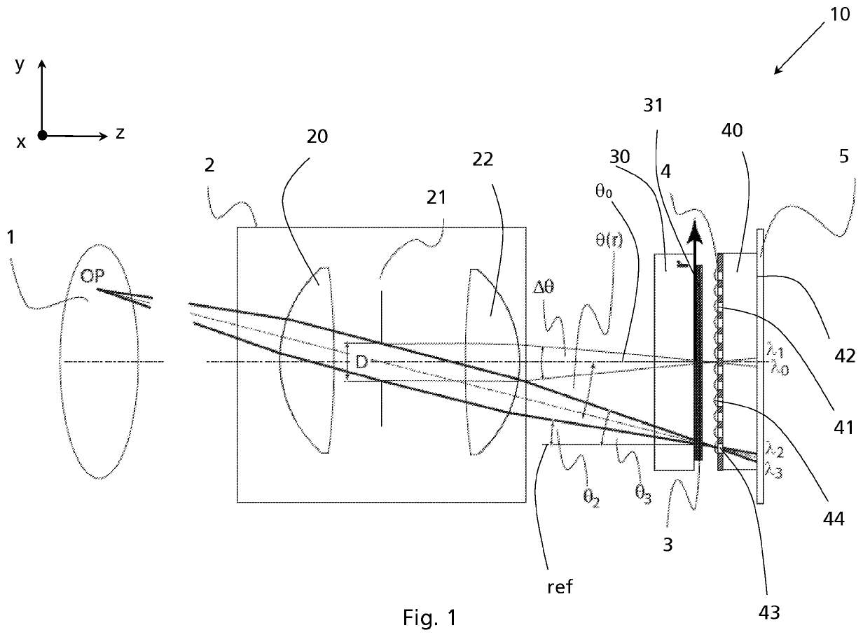

FIG. 1 illustrates schematically an embodiment of a multi-spectral light-field device 10 according to the invention. The illustrated multi-spectral light-field device 10 comprises:
an imaging component 2, arranged for imaging at least a part of the light-field emitted by at least one object point OP of an object 1; in the illustrated case, the imaging component 2 comprises a first imaging lens 20, followed by an aperture 21 having a diameter D and by a second imaging lens 22; the presence of two imaging lenses is not necessary, a single imagining lens 20 or 22 is sufficient,
an optical filter 3, between the imaging component 2 and a micro-lens array 4,
the micro-lens array 4, and
an image sensor 5.

Alternatively, the imaging component can be made of more than two lens components.

The illustrated optical filter 3 comprises a substrate 30 and one or more layers (of coatings) and/or one or more structures 31, supported by the substrate 30. In the embodiment of FIG. 1, the filter 3 faces the micro-lens array 4.

The micro-lens array 4 comprises a set of micro-lenses 44 and a substrate 40. In the embodiment of FIG. 1, the set of micro-lenses 44 faces the optical filter 3. Each micro-lens 44 is placed on a first surface 41 of the substrate 40, so as to cover the corresponding aperture 43. In alternative, the micro-lens array 4 is devoid of aperture 43; however in this case the functioning of micro-lens array 4 is not as good as with apertures 43. The second surface 42 of the substrate 40, opposite to the first surface 41, is attached, for example directly attached, to the image sensor 5, comprising e.g. an array of light-detecting elements, e.g. pixels, not illustrated. The image sensor 5 allows to detect the image formed by the micro-lenses.

In FIG. 1, the first surface 41 of the substrate 40 is substantially parallel to the second surface 42 of the substrate 40, and substantially parallel to the optical filter 3.

In FIG. 1, light from a single object point OP at a determined position X, Y in the object plane and at certain distance Z (e.g. Z=g) is imaged by the imaging component 20 with a focal length f towards a micro-lens array 4.

The micro-lens array 4 is imaging the plane of the aperture 21 with coordinates Aₓ, A_{y} onto the image sensor 5. Thus, parts of the light-field of each object point OP are captured, wherein the spatial distribution on the image sensor 5 is depending onto the transmitted angles of the optical filter 3.

In FIG. 1, the (polar) angles of incidence θᵢ on the filter are measured from a reference direction ref, which is perpendicular to the main plane P of the optical filter 3. In general, the angles of incidence are measured in polar coordinates with regard to an entrance plane, which is defined in this context as the plane normal to the optical axis of the device 10, and having at least a point in common with the optical filter 3, wherein this point is at a distance r from the optical axis. The distance r is the radius of the polar coordinates used.

The optical filter 3 is placed between the imaging component 2 and the micro-lens array 4. The optical filter 3 has the inherent property to transmit the spectral distributions, e.g. the wavelengths λᵢ in the illustrated embodiment, in dependency of the angles of incidence, where θ denotes the radial angle and it, the azimuthal angle of incidence of the rays on the optical filter 3.

The micro-lens array 4 converts the spectral distribution to a certain spatial position on the image sensor 5, denoted in the following by the coordinates x and y. The power at sensor position L(x, y) is depending on the filter transmission function T(λ, ϕ, θ) according to the following formula:

L(x,y)=L(Aₓ,A_{y})T(λ,ϕ,θ) (1)

Since each micro-lens 44 allocates for each point of the aperture 21 a different point in the sensor plane of the image sensor 5, and each aperture point causes a different angle of incidence θᵢ on the optical filter 3, the spectral content of the object point OP is spatially distributed onto the image sensor 5.

According to the invention, parts of the spectral and directional content of the light-field of each object point are captured. For object identification, the captured spectral, spatial and angular data are analysed. In one preferred embodiment and as discussed below, a machine-learning module is used for object identification.

In other words, the optical filter 3 is arranged so as to transform an input signal defined on a range of incidence angles into an output signal comprising a spectral distribution associated to an angular distribution. In other words, the output signal comprises angle-dependent spectral contents of the light-field. Those angle-dependent spectral contents are thus spatially distributed on an image plane by the micro-lens array 4.

The optical filter 3 allows then to create a wavelength and/or polarization dependent spatial distribution of the light-field on the image sensor 5.

Advantageously, the multi-spectral light-field device 10 according to the invention is sufficiently compact and therefore it can be integrated into a mobile device as a smartphone. In one preferred embodiment, the size of the device 10 is ˜3×3×3 mm³.

Advantageously, the multi-spectral light-field device 10 according to the invention transmits the spectrum for an entire image without specific bands (“hyperspectral”). Therefore, it can be adapted to any type of image sensor 5, whose pixel resolution will the spectral resolution.

Advantageously, the multi-spectral light-field device 10 captures information within one frame: therefore, it is a snap-shot camera that can measure the properties of moving objects.

The spectral resolution of the multi-spectral light-field device 10 can be tuned by the balancing of the F-number of the imaging lens 22, 24 of the imaging component 2, the filter function of the optical filter 3, and the AOI on the micro-lens array 4. Depending on the filter function, its layout and distribution, different embodiments are described in the following.

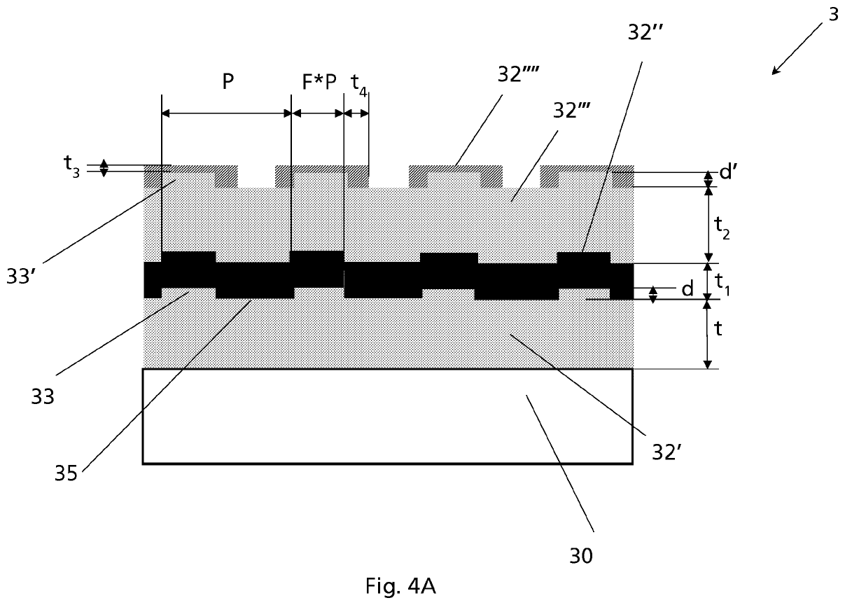

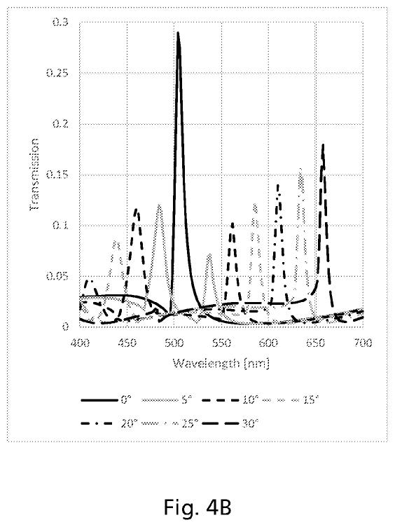

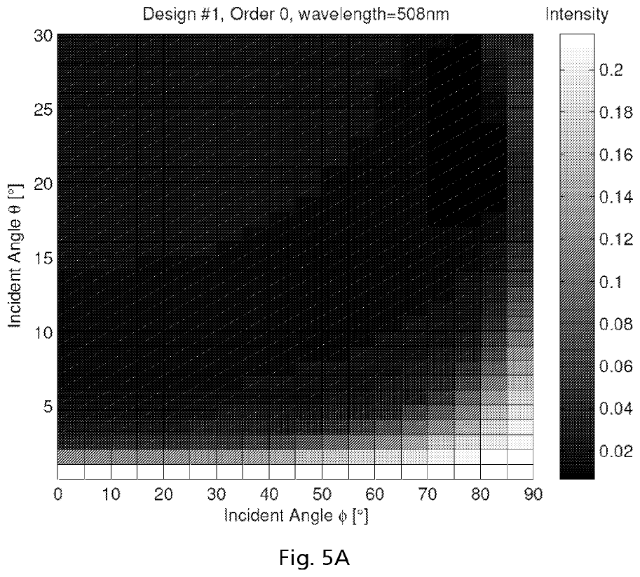

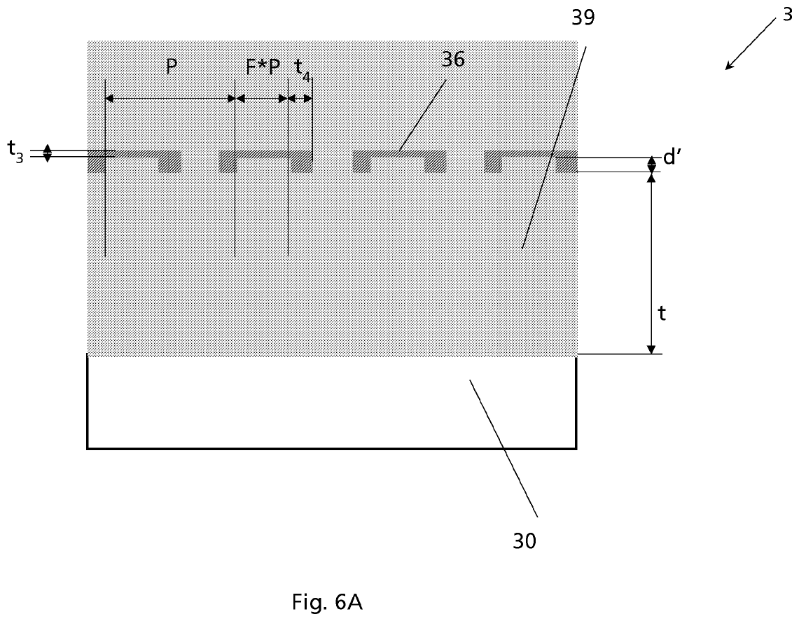

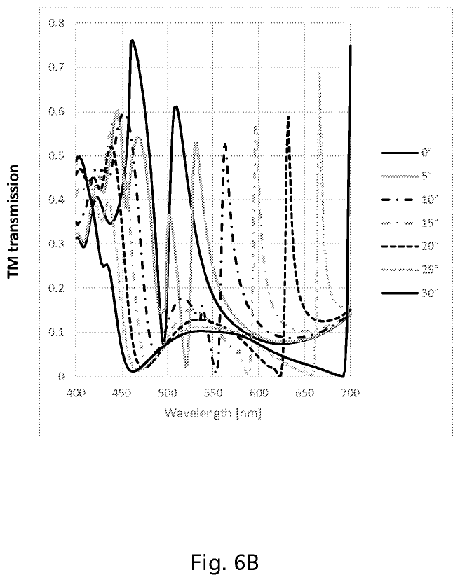

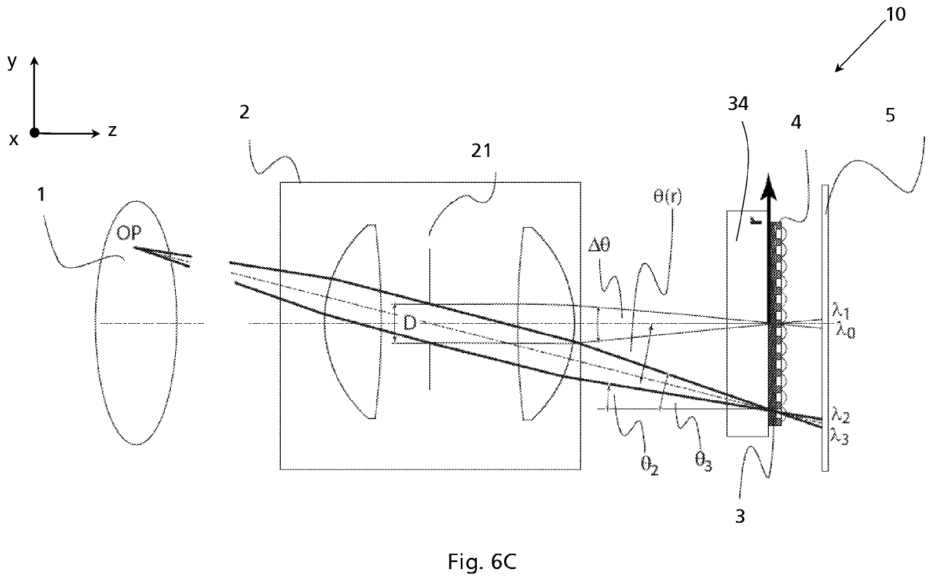

In a first embodiment, an optical filter 3 characterised by a single filter function is used. This optical filter 3 comprises at least one layer. For example, the optical filter of FIG. 4A comprises three layers and the optical filter of FIG. 6A comprises one layer.

In one preferred embodiment, the imaging component 2 is adapted to the optical filter 3. For example, the imaging component 2 is arranged so as to set the range of incidence angles on the optical filter 3, e.g. by adjusting the F-number F # of the imaging component 2 so that the set range of incidence angles on the optical filter 3 includes the angular limits of the filter transmission function. In other words, the imaging component has an F-number so that the range of incidence angles on the optical filter is within the angular acceptance of the optical filter.

The opposite strategy could be used as well, setting up a gradient or step-wise filter function that matches the range of incidence angles of the imaging component 2. In this case, the optical filter 3 has a filter transmission function which is not constant along the filter's radial dimension r to fit a non-constant range of incidence angles along the filter's radial dimension r set by the imaging component 2, as will be discussed later.

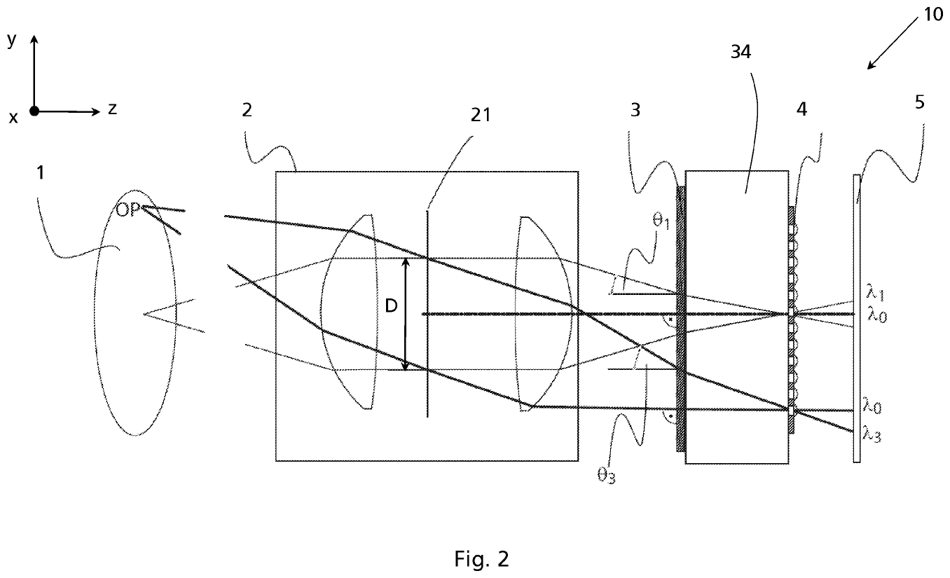

An example of adapting the imaging component 2 to the optical filter 3 is described with reference to FIG. 2.

For objects at a distance Z=g much larger than the focal length f, for example g>100×f or g>1000×f, the cone angle of the light-field is given by the aperture diameter D, the chief ray angle θ(r), and the focal length f of the imaging lens having an F number F #=f/D:

$$θ = 2 arctan [ \frac{D {cos}^{2} θ ( r )}{2} ( \frac{1}{f} - \frac{1}{g} ) ] \approx 2 arctan [ \frac{{cos}^{2} θ ( r )}{2 {F}_{\#}} ] \qquad ( 2 )$$

For the object point at the position X=Y=0, its light-field's spectral range is λ₀(θ₀)<λ<λ₁(θ₁), where the minimum angle of incidence on the optical filter 3 is θ₀=0° and the maximum angle is θ₁, wherein:

$$tan {θ}_{1} = [ \frac{D}{2} ( \frac{1}{f} - \frac{1}{g} ) ] \approx \frac{1}{2 {F}_{\#}} \qquad ( 3 )$$

The filter function T(λ, ϕ, θ) is constant, i.e. it does not depend on the optical filter's radial dimension r, visible e.g. on FIG. 1. This allows to have an optical filter with a single homogeneous structure (or maximum a few), which is more cost-effective to process than a mosaic or gradient optical filter.

The transmitted spectrum is changing with the chief ray angle θ(r), illustrated in FIG. 1. The outmost light-field may include the spectral range of λ₂(θ₂)<λ<λ₃(θ₃), wherein:

tan θ₂=tan θ(r)−tan θ₁ and tan θ₃=tan θ(r)+tan θ₁ (4)

In this case, the wavelengths λ<λ₂(θ₂) would not be transmitted for largest chief rays θ(r). In one embodiment and for a constant filter function, the optical design provides for each point in the optical filter plane a minimum angle of incidence of θ=0° by a large aperture that fulfils the equation

$$tan {θ}_{1} = tan θ ( {r}_{max} ) \approx \frac{1}{2 {F}_{\#}} \qquad ( 5 )$$

so that tan 02 becomes zero. Thus, the common spectral range of central and marginal light-fields is extended to λ₀(θ₀)<λ<λ(θrₘₐₓ), as illustrated in FIG. 2.

In the embodiment of FIG. 2, the optical filter 3 and the micro-lens array 4 share the substrate 34. One or more layers and/or one or more structures 31 of the optical filter 3 are realised on a first surface of the substrate 34 and the micro-lenses are realised on a second surface of the substrate 34, opposite to the first, and facing the image sensor 5. This feature is independent on the large diameter D of the aperture 21. In the embodiment of FIG. 2, the image sensor 5 is not directly connected to the micro-lens array 4. This feature is independent on the large diameter D of the aperture 21 and also on the common substrate 34.

The transmission filter function of the optical filter 3 of the device according to the invention allocates for the given angular width Δθ a spectral width Δλ. For example, the following values Δθ=52°, θ₂=0° and θ₃=30° correspond to a range of AOI range from −30° to 30°.

An AOI-dependent filter can be realized from diffraction and/or interference effect, generating resonances in the scattered field also known as physical colours. The structure of the optical filter can be homogeneous, i.e. comprising only one set of parameters. For interference filters, this set of parameters comprises e.g. the thicknesses and refractive indexes of the interference layers. For diffractive waveguides, this set of parameters comprises e.g. the thicknesses and refractive indexes of the thin film coatings, the periodicity, the fill factor and depth of the protrusions. The incident light on the optical filter 3 is characterized in particular by its wave vector kᵢₙ. The optical filter 3 on the other hand is characterized by a resonance along a given axis x and a resonance wavelength λᵣₑₛ, usually obtained from a constructive interference effect. This condition reads:

$${k}_{in , x} = \vert {k}_{i n} \vert cos {θ}_{i n} = \frac{2 π n}{λ} cos {θ}_{i n} \approx \frac{2 π n}{{λ}_{res}} \qquad ( 6 )$$

where n is the refractive index of the resonance medium and θᵢₙ is the incidence angle. Thus, a relationship between the incidence angle and the wavelength is achieved.

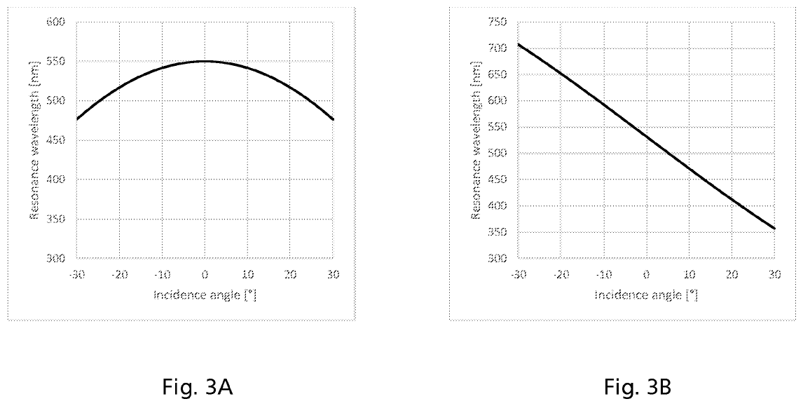

Such a dispersion can be obtained for example with an optical filter which is an interference filter. In one embodiment, the interference filter comprises stacked dielectric layers, wherein the layers are of high- and low-refractive index and their thickness is in the order of the wavelengths or below. By an appropriate layer design comprising establishing the number, thicknesses and refractive index of the interference layers, a resonance is created, which allows only a certain wavelength to transmit the filter at a certain input and output angle. Such interference filters provide a maximum angular drift of up to 30 nm to 60 nm for e.g. Δθ/2=30° to 40°. An estimation of the resonance wavelength as a function of the AOI for λᵣₑₛ=550 nm is shown in FIG. 3A.

In another embodiment, the AOI-dependent optical filter comprises a waveguide with periodic corrugation, as it can show a larger spectral range (SR). In such case, a resonance is accomplished when the light is coupled by the periodic corrugation (e.g. a grating) into the plane of the waveguide (effect known as Wood-Rayleigh anomaly), wherein:

$${n}_{1} sin {θ}_{i n} = {n}_{2} + m \frac{λ}{P} \qquad ( 7 )$$

where θᵢₙ is the incidence angle of the wavelength λ, n₁ and n₂ are the refractive index of the superstrate and of the substrate, P is the periodicity of the corrugation and m the diffraction order. An estimation of the resonance wavelength as a function of the AOI for
P=350 nm, n₁=1 and n₂=1.52 is shown in FIG. 3B.

The angular range from −30° to 30° illustrated in FIG. 3B corresponds to peak positions ranging from 360 nm to 700 nm covered by a filter having a single filter function. In this case, the given filter spectral range SR would correspond to the spectral range SR covered by the device.

FIG. 4A illustrates a cut view of an optical filter of the multi-spectral light-field device according to the invention, wherein the optical filter 3 comprises a dispersive resonant waveguide grating. It is an example of an optical filter comprising a waveguide with periodic corrugation. It is an example of an optical filter having a single filter function.

Depending on the waveguide materials, the light coupled in transmission at resonance has a high amplitude, while other wavelengths for the same incidence angle have a low amplitude. Therefore, a filtering effect is built, which can be narrowband in the example of FIG. 4A. More details of implementation of this filter can be found in the document EP3617757, filed by the applicant.

In the example of FIG. 4A, the optical filter 3 comprises a glass substrate 30, and a layer comprising a first layer 32′, made of a material with refractive index lower than 1.6, e.g. Sol-gel, with a thickness t and periodic corrugation with period P and comprising a series of protrusions 33, each protrusion being followed by a slot 35. In FIG. 4A, the parameters d indicates the height of the periodic protrusion 33 with regard to the slot 35.

The optical filter 3 of FIG. 4A comprises also a second layer 32″, made of a material with refractive index higher than 1.9, for example of ZnS, with a thickness t₁ and a similar or the same periodic corrugation of the first layer 32′, wherein the height of the protrusion is different (d′ instead of d).

The optical filter 3 of FIG. 4A comprises also a third layer 32′″, made of a material with refractive index lower than 1.6, for example of SiO₂, with a thickness t₂ and the same periodic corrugation of the first layer 32′.

Finally, the protrusions and part of the slots (over a length t₄ for each side of the protrusion) of the third layer 32′″ are covered by a coating 32″″, made e.g. of Al, and having a thickness t₃ over the protrusions of the third layer 32′″.

In the example of FIG. 4A, P=320 nm, d′=30 nm, d=70 nm, FxP=0.7, t=10 μm, t₁=35 nm, t₂=100 nm, t₃=30 nm and t₄₌₂₀ nm.

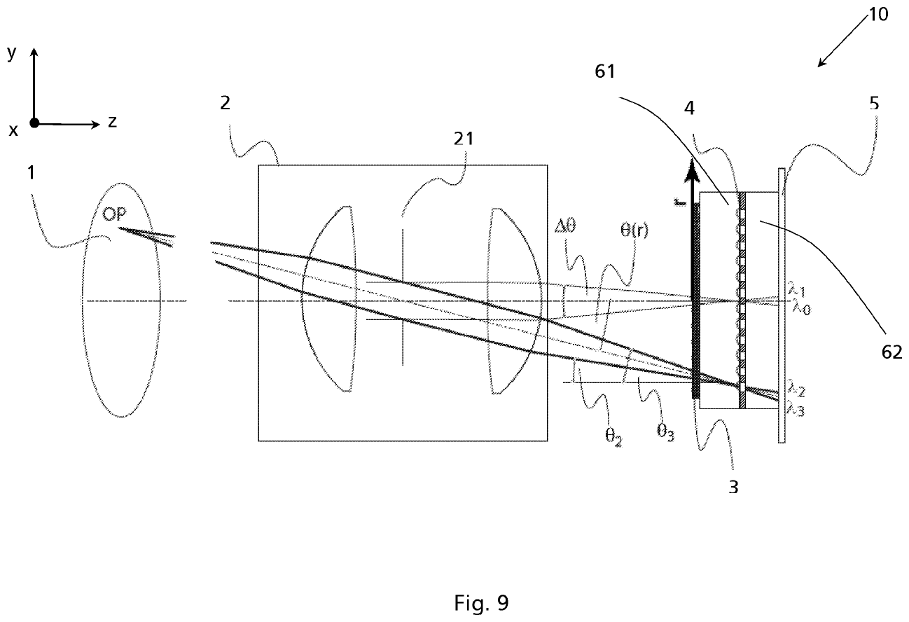

In one preferred embodiment, the dispersive resonant waveguide grating filter 3 of FIG. 4A is realised on a common substrate shared with the micro-lens array 4 and on the side of the common substrate opposite to the side where the micro-lenses are, as illustrated e.g. in FIG. 2 or 9.

In one preferred embodiment, the dispersive resonant waveguide grating filter 3 of FIG. 4A is not encapsulated (as in the case of FIG. 6C for example), i.e. surrounded by an envelope, and requires a contact with the surrounding environment (e.g. air), as shown for example in FIG. 2, 8 or 9. In fact, encapsulating the dispersive resonant waveguide grating filter 3 of FIG. 4A could worsen the filter resonance.

When the incidence angle is varied, the resonance condition is spectrally shifted and the transmission peak is shifted, too, as illustrated in FIG. 4B. Therefore, a range of wavelengths can be filtered with the single homogeneous structure, e.g. in the device 10 as illustrated in FIG. 1.

FIG. 4B reveals that two peaks are present per incidence angle for a non-normal incidence, corresponding to in-coupling using the minus first and first orders of diffraction in the plane of the waveguide. Although the intensity of the peaks is not the same, this can introduce an uncertainty in the extraction of the spectral signal on the image sensor.

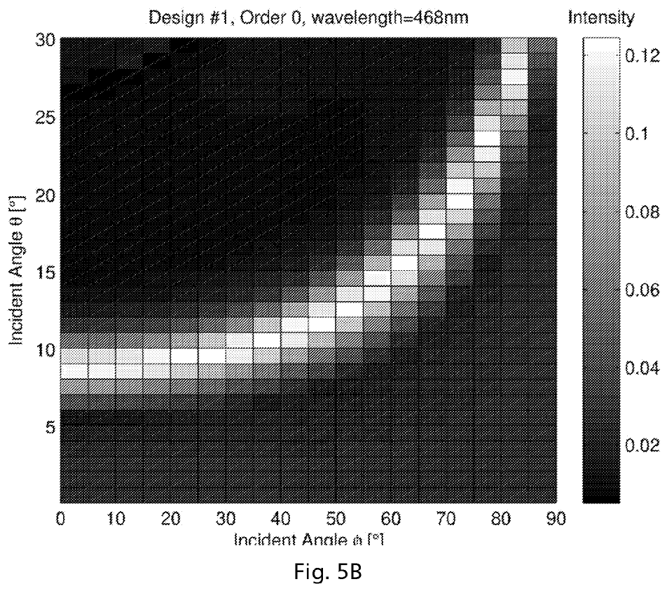

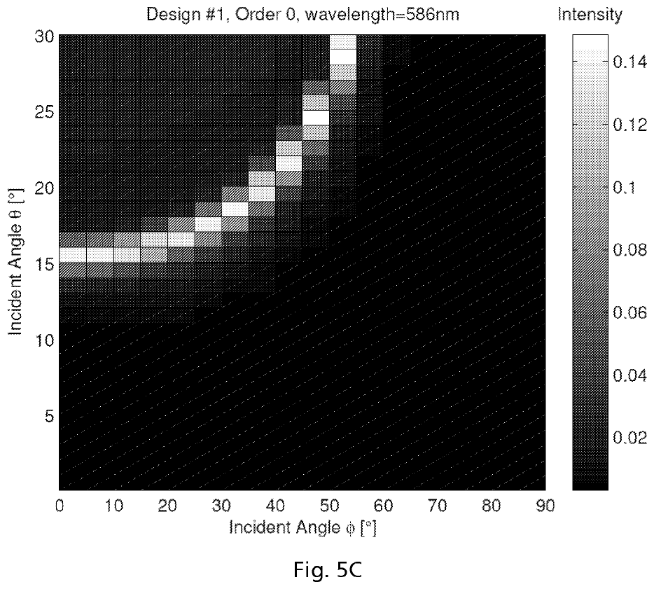

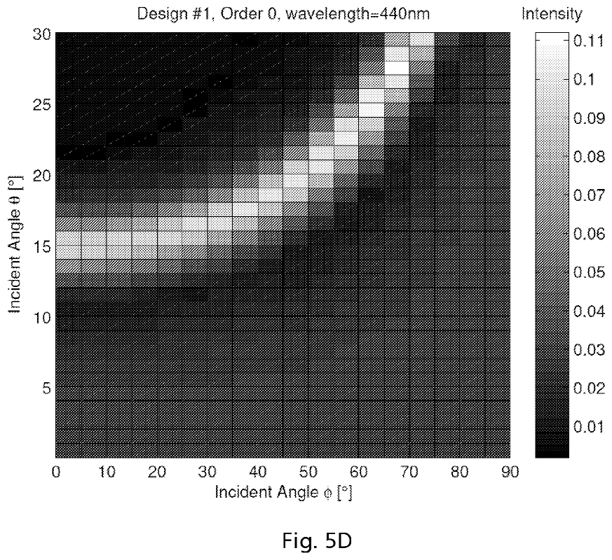

This uncertainty can be lifted by considering the full dispersion of the filter, along both polar and azimuthal angles, as illustrated in FIGS. 5A to 5D, showing the intensity for a fixed wavelength as a function of the polar θ and azimuthal it, incidence angles for the optical filter of FIG. 4A and for different wavelengths (508 nm in FIG. 5A, 468 nm in FIG. 5B, 586 nm in FIG. 5C and 440 nm in FIG. 5D). The azimuthal angle is defined here so that ϕ=0 is corresponding to the incidence angle along the grating lines. Standard definitions of polar and azimuthal angles is then assumed.

Although the peak position is the same for ϕ=0° in FIGS. 5C and 5D, they diverge from each other as the azimuthal angle ϕ is increased. This implies that the image of the spectral signal below a micro-lens will be significantly different between 440 nm and 586 nm.

A resonant waveguide grating filter comprises subwavelength structures to couple light into and out of wave-guiding layers, made of metallic or dielectric or a combination of metallic and dielectric materials. The structures can be fabricated by lithography or UV-replication of a UV-curable material.

FIG. 6A illustrates a cut view of an optical filter 3 of the multi-spectral light-field device according to the invention, wherein the optical filter 3 comprises an encapsulated dispersive resonant waveguide grating. It is a plasmonic filter encapsulated in an envelope, e.g. made of Sol-gel, yielding a similar AOI-dependent filtering effect, as illustrated in FIG. 6B.

In the example of FIG. 6A, the optical filter 3 comprises a substrate 30, made e.g. of glass, and periodic grating comprising subwavelength structures 36, made e.g. of Ag, having in the example a bridge-shaped cross section. The periodic subwavelength structures 36 have two legs with a thickness d′ and a horizontal part with a thickness t₃. The total length of each structures 36 is 2×t₄+F×P, wherein t₄ is the length of the leg. The number and/or the shape periodic subwavelength structures 36 of FIG. 6A are not limitative.

In the example of FIG. 6A, P=320 nm, d′=30 nm, d=70 nm, FxP=0.7, t=10 μm, t₁=35 nm, t₂=100 nm, t₃=30 nm and t₄=20 nm.

The manufacturing of the corrugation of the resonant waveguide gratings used as examples in this application is not limited to UV replication, but can be performed with other methods such as hot embossing, electron beam lithography, photolithography, deep UV photolithography, laser interference lithography, or focused ion beam milling. The layers material deposition can be realized for example by thermal evaporation, sputtering or by wet solution processing.

The invention is not limited to the described examples of AOI-dependent optical filters 3. Alternatively, the AOI-dependent optical filter 3 can be based for example on resonant plasmonic nanostructures, coated nanoparticles, dielectric or metallic meta-surfaces or diffraction gratings.

FIG. 6B illustrates the transmission spectra of the filter of FIG. 6A, as a function of the wavelength and of the incidence angle. When the incidence angle is varied, the resonance condition is spectrally shifted and the transmission peak is shifted, too, as illustrated in 6B. Therefore, a range of wavelengths can be filtered with the single homogeneous structure, e.g. in the device 10 as illustrated in FIG. 1.

FIG. 6C illustrates schematically another embodiment of a multi-spectral light-field device 10 according to the invention, comprising an encapsulated optical filter 3. In the illustrated example, the optical filter 3 and the micro-lens array 4 share a common substrate 34, as in FIG. 2. However, in the case of FIG. 6C, they are realised on the same side of the common substrate 34, preferably on the side facing the image sensor 5. In particular, in the case of FIG. 6C, the micro-lens array 4 is realised on top of the optical filter 3, which is encapsulated. For example, the optical filter 3 of FIG. 6C can be the filter illustrated in FIG. 6A. The embodiment of FIG. 6C allows to realise a really compact multi-spectral light-field device 10.

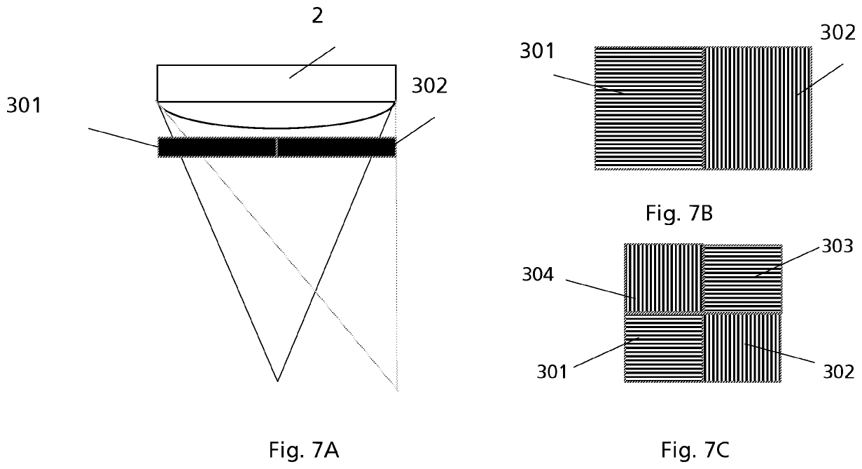

The optical filter 3, e.g. the optical filter of FIG. 6A, may show a behaviour that is depending on the polarization state of the light. In order to measure the hyperspectral function of unpolarised light, the AOI-dependent filter may comprise two adjacent sub-zones 301, 302, i.e. two sub-zones sharing a side, with orthogonal orientations, as illustrated in FIG. 7A, each sub-zone being an optical filter 3 having a polarized response: this allows to build a system response independent of the incident light polarization. FIG. 7B illustrates a top view of the optical filter of FIG. 7A.

FIG. 7C illustrates a top view of an arrangement of two optical filters (i.e. of four sub-zones) of FIGS. 7A/7B. In other words, the optical filter of FIG. 7C comprises four sub-zones 301, 302, 303, 304, wherein adjacent sub-zones have orthogonal orientations. This effect is not limited by the number of sub-zones and can be obtained with more subzones, and also more different orientations of the lines.

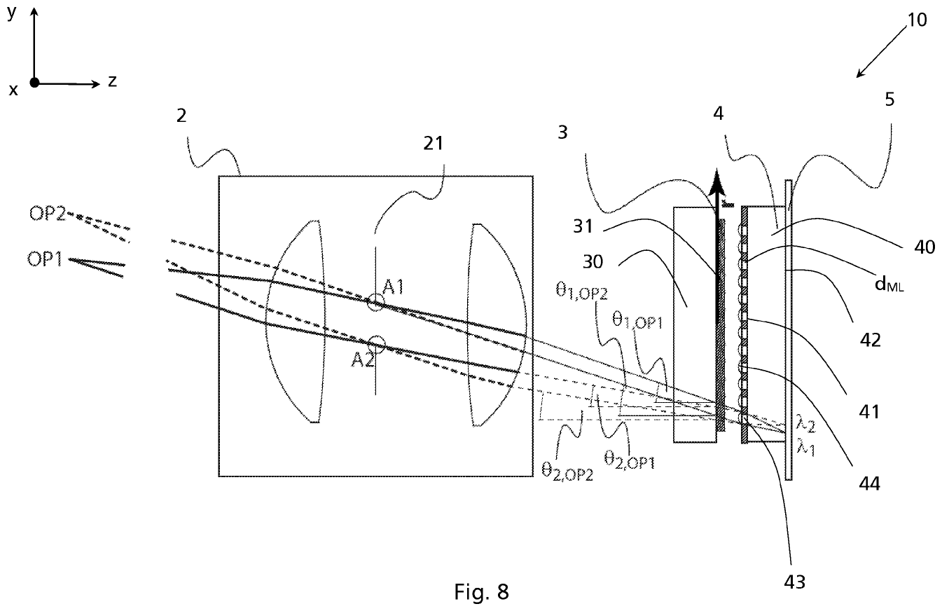

FIG. 8 illustrates schematically another embodiment of a multi-spectral light-field device 10 according to the invention, for two different object points OP1 and OP2. Spectral distribution of the light-field sketched for two different object points OP1, having coordinates X₁, Y₁, Z₁ and OP2, having coordinates X₂, Y₂, Z₂, wherein Z₁=Z₂=g. The spatial content of the captured light-fields of OP1 and OP2 is superimposing on the image sensor 5, whereas the directional spectral content imprinted by the optical filter 3 is separated. For simplicity, the azimuthal angles α of the light-fields are not shown.

The required spectral resolution for a multi-spectral light-field device 10 can be designed as explained in the following. A single micro-lens 44 focuses all rays passing a single aperture position, e.g. A1 in FIG. 8, to a single image sensor position (x, y).

Light rays emanating of the object points in the range of OP1 to OP2 may pass through the identical aperture positions and are superimposing on the image sensor 5, at an image point. The spectral width at the image sensor position (x, y) is thus determined by the back focal length f of the imaging lens 20, 22 and the diameter d_{ML} of the micro-lens' aperture:

$$\begin{matrix}tan ( {θ}_{A 1 , OP ( {X}_{1} , {Y}_{1} , {Z}_{1} = g )} ) - tan ( {θ}_{A 1 , OP ( {X}_{2} , {Y}_{2} , {Z}_{2} = g )} ) \approx \frac{{d}_{ML}}{f} & ( 8 ) \\ with δ θ = {θ}_{A 1 , OP ( {X}_{2} , {Y}_{2} , {Z}_{2} = g )} - {θ}_{A 1 , OP ( {X}_{1} , {Y}_{1} , {Z}_{1} = g )} & ( 9 )\end{matrix}$$

In one embodiment, it is possible to limit the spectral deviation within said image point, if the angular acceptance angle of each micro-lens is in the range of 1°<δθ<2° only. This can be achieved by a small micro-lens diameter d_{ML}, e.g. by a micro-lens diameter d_{ML}≤100 μm. e.g. d_{ML}≤10 μm. In dependency of the optical filter function, the spectral precision may be in the order of δλ≤1 nm.

The micro-lens array 4 may also have an aperture array to improve its imaging quality. Each micro-lens can have a square, circular or hexagonal basis. The micro lens arrays can be placed in a square or hexagonal (closely packed) array. The micro-lens array can also be replaced by an array of diffractive lenses, Fresnel lenses or diffractive optical elements to perform the same functionality.

The micro-lens array 4 may consist of a single array of micro-lenses or several micro-lens arrays, where each micro-lens array may have its own substrate or is processed on the back-side of another micro-lens array. In one embodiment, the micro-lens array 4 is processed directly on top of the image sensor 5, as illustrated in FIGS. 1 and 8.

In the embodiment of FIG. 8, as in FIG. 1, the set of micro-lens 44 faces the optical filter 3. Each micro-lens 44 is placed on a first surface 41 of the substrate 40, so as to cover the corresponding aperture 43. In alternative, the micro-lens array 4 is devoid of aperture 43; however in this case the functioning of micro-lens array 4 is not as good as with apertures 43. The second surface 42 of the substrate 40, opposite to the first surface 41, is attached, for example directly attached, to the image sensor 5, comprising e.g. an array of light-detecting elements, e.g. pixels, not illustrated. The image sensor 5 allows to detect the image formed on the second surface 42. It must be understood that this arrangement is not necessary for limiting the spectral deviation within the image point.

The illustrated optical filter 3 comprises a substrate 30 and one or more layers and one or more structures 31 on top of the substrate 30. In the embodiment of FIG. 8, as in FIG. 1, the one or more layers and one or more structures 31 face the micro-lens array 4. It must be understood that this arrangement as well is not necessary for limiting the spectral deviation within the image point. FIG. 9 illustrates schematically another embodiment of a multi-spectral light-field device 10 according to the invention, where the micro-lens array 4 is arranged between a high-refractive index spacer 62 and a low-refractive index spacer 61, where the refractive index difference is high enough (i.e. higher than 0.2, preferably higher than 0.4, for example higher than 0.5) to generate a refraction by the micro-lenses, and where the optical filter 3 is arranged on the low-refractive index spacer 61. Further space is gained and the optical filter 3 and the array of micro-lenses 4 can be directly processed on the sensor 5. This embodiment has the advantage to have the micro-lens array 4 and the optical filter directly attached to the image sensor 5.

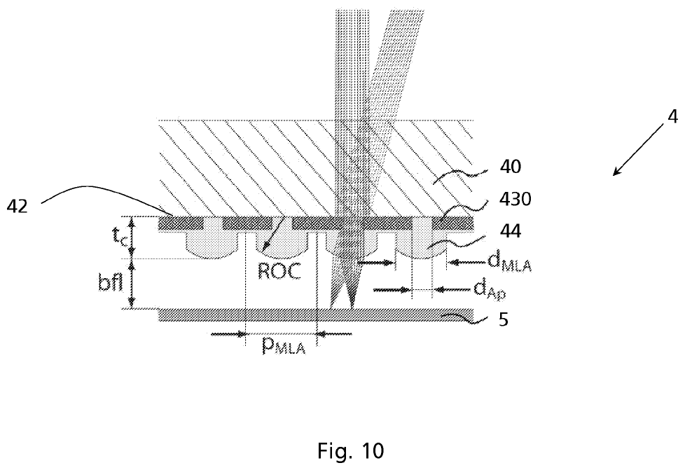

FIG. 10 illustrates a cut view of an embodiment of the micro-lens array 4 and of the image sensor 5 of the multi-spectral light-field device according to the invention. It comprises a substrate 40, e.g. a glass-like substrate, wherein on a surface 42 of this substrate, i.e. the surface facing the image sensor, there is an aperture array 430, which can be produced e.g. by lithography.

An array of micro-lenses 44 is then placed on top of this aperture array 430. In one embodiment, the micro-lens 44 are replicated a material curable by ultraviolet light, for example in a uv-curable sol-gel material. Alternatively, the micro-lens array can be fabricated by photolithography. In the embodiment of FIG. 10, the image sensor 5 is placed at a distance t_{c}+bfl from the surface 42 of the substrate 40.

Typical values for the micro-lens array parameters comprising spherical micro-lenses for an imaging lens of focal length f=1.44 mm considering two different F-numbers are given in the table 1 here below for a uv-curable sol-gel material:

TABLE 1

| | | | | | | | | | σ_{LP}/diffr. |
|---|---|---|---|---|---|---|---|---|---|
| F# | CRAₘₐₓ | θ₁ | σₛₚₒₜ/p_{MLA} | d_{AP} | d_{MLA} | ROC/t_{c} | ML bfl | p_{MLA} | limit |
| 1.17 | 35° | 26° | 38 μm | 32 μm | 46 μm | 30 μm | 36 μm | 34 μm | 1.8 μm |
| | | | | 30 μm | 46 μm | 30 μm | 39 μm | 36 μm | 1.4 μm |
| | | | | 24 μm | 40 μm | 30 μm | 44 μm | 38 μm | 1.4 μm |
| | | | | 20 μm | 36 μm | 30 μm | 48 μm | 40 μm | 1.8 μm |
| 1 | 35° | 31° | 59 μm | 36 μm | 56 μm | 40 μm | 57 μm | 60 μm | 1.2 μm |
| | | | | 40 μm | 62 μm | 45 μm | 65 μm | 64 μm | 1.3 μm |
| | | | | 40 μm | 66 μm | 50 μm | 77 μm | 74 μm | 1.4 μm |
| | | | | 30 μm | 58 μm | 50 μm | 84 μm | 78 μm | 2.0 μm |
| | | | | 50 μm | 74 μm | 50 μm | 67 μm | 68 μm | 2.1 μm |

wherein:
F # indicates the F number of each micro-lens 44
CRAmax indicates the maximum chief ray angle of the imaging component 2
θ₁ indicates the maximum incidence angle on the filter 3
σₛₚₒₜ indicates the root mean square value of the radius of an imaged object point; the spot is created by the imaging component 2 in the plane of the micro-lens array 4
p_{MLA} indicates the period of the micro-lens array 4
d_{AP} indicates the diameter of the aperture of the aperture array 430
d_{MLA} indicates the diameter aperture of each micro-lens 44
ROC indicates the radius of curvature of each micro-lens 44
t_{c} indicates the thickness of each micro-lens 44
(ML) bfl indicates the back-focal length of the micro-lens array 4
σ_{LF} indicates root mean square value of the spot radius on the image sensor or (if the ray-traced spot size is smaller than the diffraction limit) the expected diffraction limit.
   The micro-lenses can also have a conical shape to reduce optical aberrations.

In one embodiment, if an imaging lens of the imaging component 2 cannot be adapted to the spectral range of the overall device 10, the filter function may have to be adapted towards the changing chief ray angle θ(r). In one embodiment, the transmission function of the filter is changing along the optical filter's radial dimension r.

T(Δ,ϕ,θ)=F(Δ,ϕ,θ,r) (10)

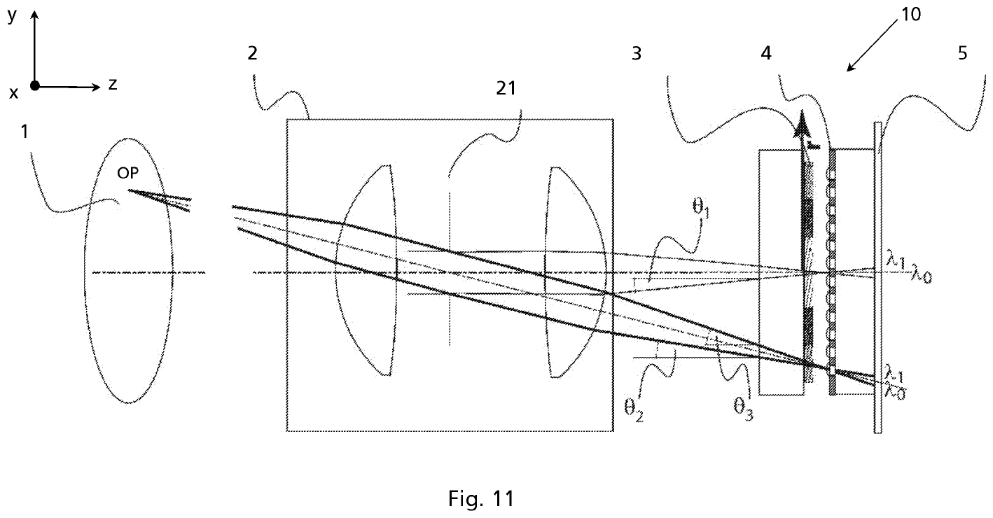

In one embodiment, the filter function F(λ, ϕ, θ, r) is a step function, as in the embodiment of FIG. 11, wherein the different grey colours of the filter 3 indicate this step function.

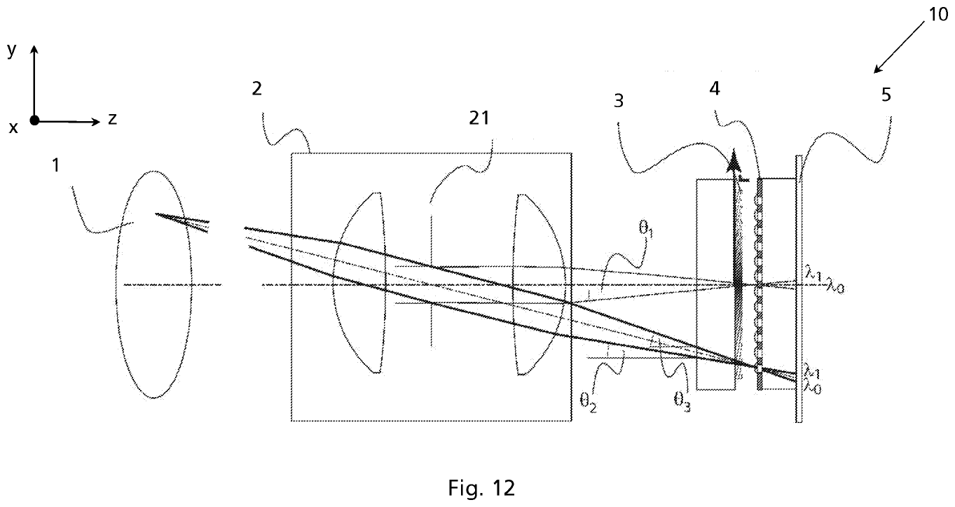

In one embodiment, the filter function F(λ, ϕ, θ, r) is a gradient function, as in the embodiment of FIG. 12, wherein the shading of the grey colours of the filter 3 indicates this gradient function.

Both configurations of FIGS. 11 and 12 can take advantage of the plurality of geometries to extend further the spectral range.

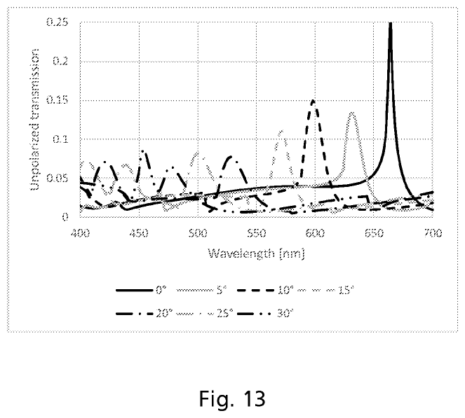

FIG. 13 illustrates the unpolarised transmission spectra of an optical filter comprising a dispersive resonant waveguide grating such as shown in FIG. 4A, with a different periodicity, as a function of the wavelength and of the incidence angle, with P=430 nm, d′=30 nm, d=70 nm, F×P=0.7, t=10 μm, t₁=35 nm, t₂=100 nm, t₃=30 nm and t₄=20 nm.

The change in steps is an approach for filters that are processed by lithography and thin film coating or other non-replication-processes like interference filters. Each filter function is realized by individual thicknesses of some of the various layers of the high- and low-index material. Different layer thicknesses have to be coated subsequently, which makes the filter fabrication quite costly, as mask design changes are required, and thus only a limited number of different filter functions can be realized.

The transmission function of plasmonic or resonant waveguide filters can be altered e.g. by solely changing the period of the subwavelength structure of the optical filter 3. This change in the period can be established in a cost effective manner, e.g. by UV-replication and thin film coating. Thus, a change of the filter transmission versus the filter radius in steps or as a gradient is feasible.

The parameters of the optical filter 3 can be adapted in order to address other spectral ranges than the visible. In particular, the periodicity increase to 0.5 μm, 1 μm and above yields resonances in the near infra-red (NIR) and (short-wave infra-red) SWIR ranges.

In one embodiment, the filter function can be processed on a (curved) surface near the imaging component, e.g. the imaging lens, or directly on the imaging lens. The integration of the optical filter on the imaging lens is cost effective.

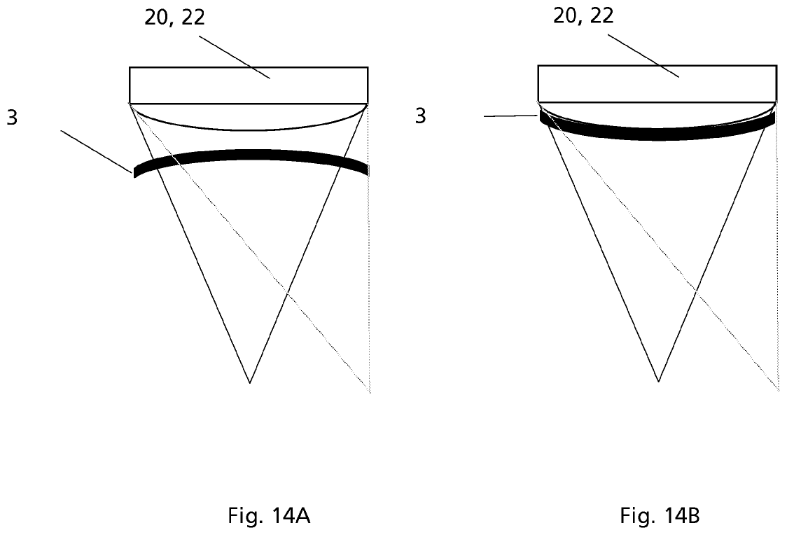

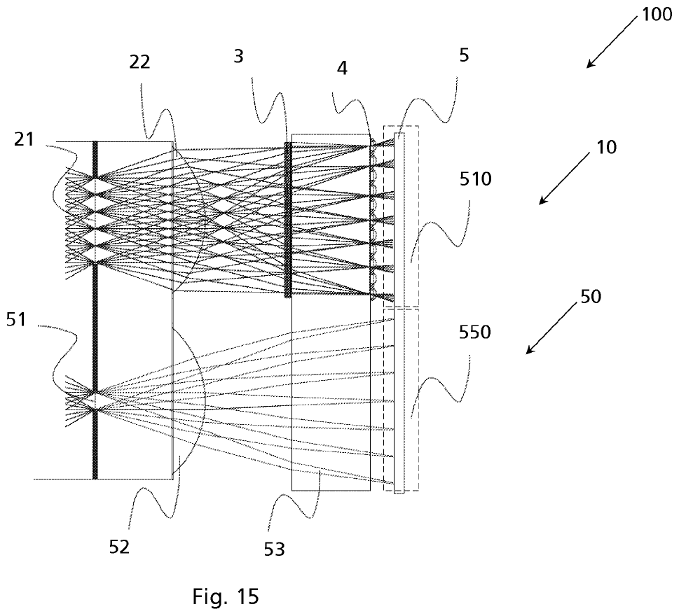

In one embodiment, the filter is processed on a curved surface near the imaging lens 20 or 22, as illustrated in FIG. 14A.

In another embodiment, the curved surface is part of the imaging lens, as illustrated in FIG. 14B. In this way, the range of incidence angles is different over the filter area, which increase the total spectral range, and the system becomes even more compact and robust.

FIG. 15 illustrates schematically an embodiment of the imaging system 100 according to the invention. This embodiment allows to further improve the spatial resolution in the reconstructed images by the device 10, especially if the device 10 comprises a large aperture as in the embodiment of FIG. 2.

In the embodiment of FIG. 15, the imaging system 100 comprises the multispectral light-field device 10, with the aperture 21, an imaging lens 22, an optical filter 3, a micro-lens array 4 and an image sensor, e.g. a sensor pixel array. The imaging system 100 comprises also a reference device, in this case a two-dimensional (2D) camera device 50 comprising, an aperture 51, an imaging lens 52 and an image sensor.

In one preferred embodiment, the imaging lenses 22 and 52 are identical.

For compactness and in order to ensure temporal consistency, it is a further advantage to implement the high-resolution 2D camera 50 onto the same image sensor 5 of the device 10 according to the invention. Since the 2D beam path is not including a lens array, the spatial resolution is (at minimum) as high as given by the image sensor 5. Thus, the 2D camera 50 is generating a high resolution 2D image on the 2D section 550 of this image sensor 5 and the multi-spectral light-field camera 10 is generating a multi-spectral light-field image on the light-field section 510 of this image sensor 5.

In order to reduce the packaging effort, it is of advantage to implement in the beam paths of both lenses the substrate 53 of the multi-spectral light-field camera 10 (without micro lens array and filter coatings). In other words, in the beam path of the 2D camera device there is the substrate 53 of the optical filter and/or of the micro-lens array 4 of the multi-spectral light-field device 10, without the micro lens-array 4 and the one or more layers and/or one or more structures 31.

In order to achieve a focused image of the object onto the 2D camera section 550 of the image sensor 5, it is proposed to adjust the aperture 51 of the 2D camera device 50, to achieve a longer focal length, so that the image plane of the 2D camera is on the image sensor. The length difference to cover is thus the thickness and the back focal length of the micro lens array. The high resolution 2D camera section 550 and the multi-spectral light-field camera section 510 build together a very compact twin camera.

All objects captured by the twin camera are captured within one frame and will not suffer from motion blur. Further, the parallax between those sections 510, 550 is improving the resolution of the third dimension.

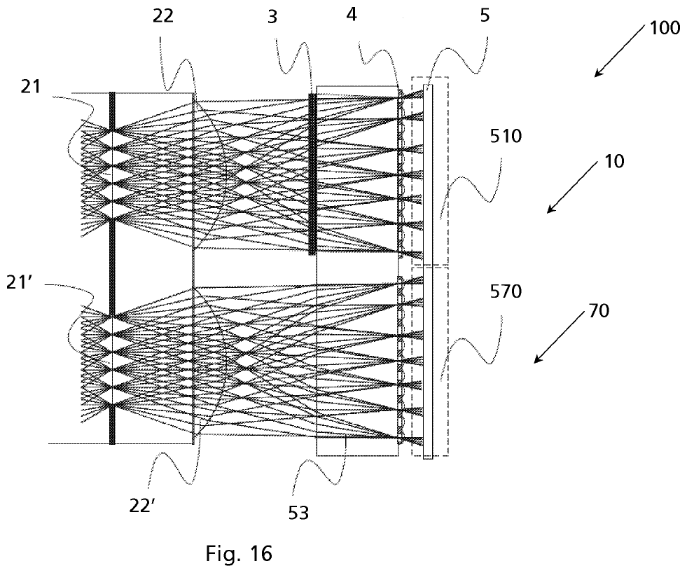

FIG. 16 illustrates schematically another embodiment of the imaging system 100 according to the invention. In this embodiment, the imaging system 100 has as a reference device 70, which is a light-field camera device comprising, an aperture 21′, an imaging lens 22′, a micro-lens array and an image sensor, so as to provide light field information independently of the spectral content.

The imaging system 100 of FIG. 16 (light-field twin camera device) provides a non-spectral light-field image from the non-spectral light-field device 70 and a multi-spectral light-field image from the multi-spectral light-field device 10 (step 110). The separated images enable a parallel image processing in object identification. Compared to an imaging system of FIG. 15 (twin-camera with a two-dimensional camera and a device 10 according to the invention), which allows a higher 2D-spatial resolution, the imaging system 100 of FIG. 16 (twin light-field camera) emphasizes 3D data and spectral data.

In other words, in the imaging system 100 of FIG. 16, in the beam path of the reference device 70 there is the substrate 53 of the optical filter 3 and/or of the micro-lens array 4 of the multi-spectral light-field device 10 according to the invention, devoid of one or more layers and/or one or more structures 31 but with the micro lens-array 4, in order to achieve a non-spectral light-field image in the light-filed section 570 of the image sensor 5 as a reference signal.

In other words again, in the imaging system 100 of FIG. 16 the reference device 70 is a light-field camera device consisting of an aperture 21′, an imaging lens 22′, a micro-lens array and an image sensor and the substrate 53 only of the optical filter 3 and/or of the micro-lens array 4 of the multi-spectral light-field device 10 according to the invention.

More than two devices 10 according to the invention in an imaging system 100 can be used as well.

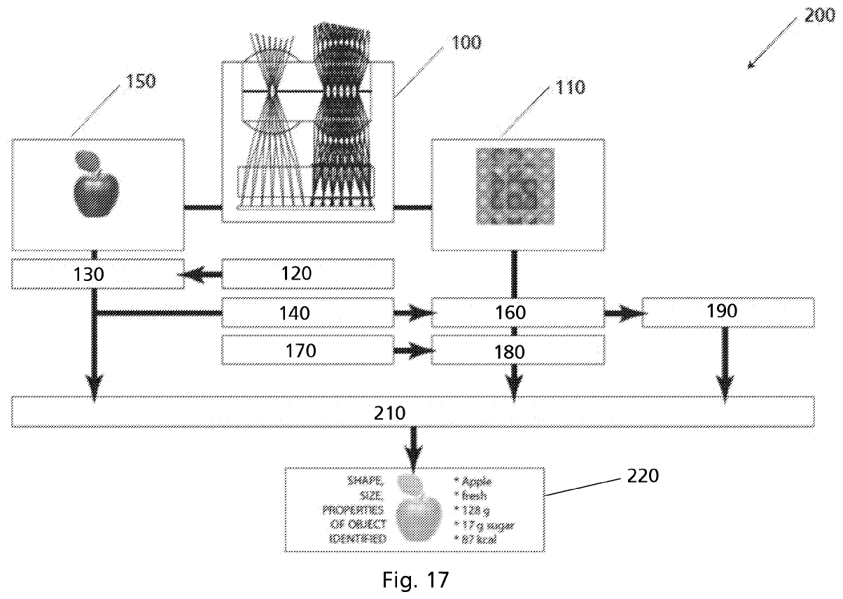

FIG. 17 illustrates a flow-chart for an object identification system 200, based on the imaging system 100 of FIG. 15, allowing separated object identification tasks in both hardware and software, for faster machine-learning based object identification.

In this context, the expression “object identification” indicates the act of recognising or naming the object and its properties, in particular its footprint, colour(s), size, spectral content, material, shape, type of reflection, surface properties, etc.

The multi-spectral light-field device 10 according to the invention, alone or in combination with a 2D camera device 50 as in the imaging system 100, takes spectral light-fields of the entire object. Each micro-lens creates a light-field depending on the spatial and spectral object point OP, the chief ray θ(r), and the imaging component parameters. For different object distances, the set of parameters is changing and the spectral and spatial content is distributed accordingly.

For object identification, the captured light-fields have to be analysed. In one embodiment, a machine-learning module, as a neural network module, is used for object identification.

In this context, the expression “machine-learning module” indicates a module which needs to be trained in order to learn i.e. to progressively improve a performance on a specific task.

The machine-learning module in a preferred embodiment is a neural network module, i.e. a module comprising a network of elements called neurons. Each neuron receives input and produces an output depending on that input and an “activation function”. The output of certain neurons is connected to the input of other neurons, thereby forming a weighted network. The weights can be modified by a process called learning which is governed by a learning or training function.

Although the neural network module is a preferred implementation of the machine-learning module, the object identification system 200 is not limited to the use of a neural network module only, but could comprise other types of machine-learning modules, e.g. and in a non-limiting way machine-learning modules arranged to implement at least one of the following machine-learning algorithms:
decision trees, association rule learning, deep learning, inductive logic programming, support vector machines, clustering, Bayesian networks, reinforcement learning, representation learning, similarity and metric learning, sparse dictionary learning, genetic algorithms, rule-based machine-learning, learning classifier systems.

In one embodiment, the neural network module is a deep neural network module, e.g. it comprises multiple hidden layers between the input and output layers, e.g. at least three layers.

The machine-learning module has been trained to recognize the target object. Only image content that is relevant for the object identification is processed, which makes the image processing by the machine-learning module superior to non-compressive image processing.

In the embodiment of FIG. 17, a twin camera device 100, e.g. as represented in FIG. 15, provides a data separation between shape and size on the one side and the spectral BRDF data (as diffusiveness, spectral content, texture) on the other side. It must be understood that the object identification system 200 is not limited to the twin camera device 100, and applies also to a multi-spectral light-field device 10 according to the invention used in combination with a machine-learning module, without a 2D camera device 50. It must be understood that the object identification system 200 is not limited to the twin camera device 100 of FIG. 15, but applies also to other imaging system described here above.

In another embodiment, multiple two-dimensional cameras are used as reference devices around the multi-spectral light-field device to cover the different viewpoints of the object.

In the embodiment of FIG. 17, the twin camera device 100 provides a 2D image from the 2D camera device 50 (step 150) and a multi-spectral light-field image from the multi-spectral light-field device 10 (step 110). The separated images enable a parallel image processing in object identification.

For example as by a human eye, the monochrome image of a fruit is sufficient to identify an object, e.g. an apple. Such an identification of an object by its shape has been taught to a first machine-learning module, as a first neural network module, with learned shaped images 120, so as to perform a shape identification (step 130) by the machine-learning module.

From the 2D image 150 it is also possible to define the region of interest or ROI (step 140). In the embodiment of FIG. 17, this ROI in combination with the multi-spectral light-filed image 110 allows to retrieve multi-spectral light-field data in the ROI (step 160).

A second machine-learning module, as a second neural network module has been taught by a set of different objects (different fruits in the example of FIG. 17) to identify properties of the object, as freshness, firmness or/and moisture content via the multi-spectral light-field images 110. This is illustrated in FIG. 17 by the learned property images step 170, which combined with the step 160 of retrieving multi-spectral light-field data in the ROI, provides the step 180 of identification of the object properties via the (second) machine-learning module.

In the embodiment of FIG. 17, the step 160 of retrieving multi-spectral light-field data in the ROI allows also to evaluate 3D data (step 190).

Evaluating the separating results of both machine-learning modules via a third-machine learning module (step 210) gives as a final result (step 220) the identified object (an apple in FIG. 17) and its properties (as its state of freshness). The third-machine learning module can be the first or the second machine learning module.

The advantage of this strategy is a reduction in the computational effort, and the possibility to reuse a once taught machine-learning module to recognize shapes in combination with a newly taught machine-learning module to recognize new properties like e.g. the gluten content.

Possible and not limitative applications of the object identification system 200 are food applications and auto-focusing applications (determination of the focal length).

### REFERENCE SIGNS USED IN THE DRAWINGS

1 Object
2 Imaging component
3 Optical Filter
4 Micro-lens array
5 Image Sensor
10 Multi-spectral light-field device
21, 21′ Aperture
20, 22, 22′ Lens
30 Substrate of the optical filter
31 One or more layers and/or one or more structures
32′ First layer of the optical filter
32″ Second layer of the optical filter
32′″ Third layer of the optical filter
32″″ Coating of the optical filter
33, 33′ Protrusion of the periodic corrugation of the optical filter
34 Common substrate between the optical filter and the micro-lens array
35 Slot of the periodic corrugation of the optical filter
36 Subwavelength structure
37 Envelope
10 Substrate of the micro-lens array
41 First surface of the substrate 40
42 Second surface of the substrate 40
43 Aperture covered by the micro-lens
44 Micro-lens
50 Reference device—Two-dimensional camera device
51 Aperture of the two-dimensional camera device
52 Imaging lens of the two-dimensional camera device
53 Common substrate between the device 10 and the device 50
61 Low-refractive index spacer
62 High-refractive index spacer
70 Reference device—(Non-spectral) light-field device
100 Imaging system (twin camera device)
110 Step of providing a multi-spectral light-filed image
120 Step of learning shaped images
130 Step of shape identification
140 Step of defining the region of interest (ROI)
150 Step of providing a 2D image
160 Step of retrieving multi-spectral light-field data in the ROI
170 Step of learning property images
180 Step of identification of the object properties
190 Step of evaluation of 3D data
200 Object identification system
210 Step of evaluation of the object properties
220 Step of delivering the result
300 Subzone of the optical filter
430 Aperture array
510 Multi-spectral light-field section of the image sensor
550 2D section of the image sensor
570 Light-filed section of the image sensor
A1 Aperture position
bfl Back focal length
d, d′ Height of the protrusion D_{Ap} Diameter of the aperture of the aperture array
d_{ML}, d_{MLA} Diameter aperture of the micro-lens
D Diameter aperture of the imaging component
OP, OP1, OP2 Object point
p_{MLA} Period of the micro-lens array
P Periodicity of the corrugation
r Optical filter's radial dimension
ref Reference direction
ROC Radius of curvature of the micro-lens
t_{c} Thickness of the micro-lens
tᵢ Thickness
θᵢ Angle
θ(r) Chief ray angle
λᵢ Wavelength

What is claimed is:

1. Multi-spectral light-field device, comprising:
an imaging component, arranged to image at least a part of the light-field emitted by at least one object point of an object and for setting an input signal comprising a range of incidence angles on an optical filter;
said optical filter having a transmission function depending on the incidence angle, so as to transform said input signal into an output signal comprising a spectral distribution associated to an angular distribution;
a micro-lens array, arranged to transform the spectral distribution of the output signal into a spatial distribution on an image plane.

2. The multi-spectral light-field device of claim 1, wherein the optical filter has a filter transmission function which is constant along the filter's radial dimension.

3. The multi-spectral light-field device of claim 2, wherein the imaging component has an F-number so that the range of incidence angles on the optical filter is within the angular acceptance of the optical filter.

4. The multi-spectral light-field device of claim 3, wherein the imaging component comprising an aperture and at least one lens, said aperture having a diameter for transmitting wavelengths having an angle of incidence on the main plane of the optical filter substantially equal to 0° that fulfills the equation
$$tan {θ}_{1} = tan θ ( {r}_{max} ) \approx \frac{1}{2 {F}_{\#}}$$
wherein:
F # is the F number of the imaging component, equal to F #=f/D,
D is the diameter of the aperture,
f is the focal length of the imaging lens
θ₁ is the maximum angle of incidence on the main plane of the optical filter.

5. The multi-spectral light-field device of claim 1, the optical filter being an interference filter.

6. The multi-spectral light-field device of claim 5, wherein the optical filter comprises stacked dielectric layers, where the layers are of high- and low refractive index and their thickness is in the order of the wavelengths or below, wherein the layers are arranged so as to create a resonance.

7. The multi-spectral light-field device of claim 1, wherein the optical filter comprises a periodic corrugation.

8. The multi-spectral light-field device of claim 7, wherein the optical filter comprises a resonant waveguide grating.

9. The multi-spectral light-field device of claim 8, wherein the optical filter comprises:
a substrate,
a coating comprising:
a first layer, made of a material with refractive index lower than 1.6, comprising a periodic corrugation comprising a series of protrusions, each protrusion being followed by a slot,
a second layer, made of a material with refractive index higher than 1.9, comprising a periodic corrugation having the period of the periodic corrugation of the first layer, wherein the height of the protrusions is different from the first layer,
a third layer, made of a material with refractive index lower than 1.6, comprising a periodic corrugation equal to the periodic corrugation of the first layer, and
a metallic layer, covering the protrusions and part of the slots of the third layer.

10. The multi-spectral light-field device of claim 1, wherein the optical filter is a plasmonic filter.

11. The multi-spectral light-field device of claim 5, wherein the optical filter is encapsulated in an envelope.

12. The multi-spectral light-field device of claim 1, wherein the micro-lens array and the optical filter share a common substrate.

13. The multi-spectral light-field device of claim 12, wherein the micro-lens array and the optical filter are realised on different sides of the common substrate.

14. The multi-spectral light-field device of claim 12, wherein the micro-lens array and the optical filter are realised on the same side of the common substrate, wherein the micro-lens array is on top of the optical filter.

15. The multi-spectral light-field device of claim 1, comprising at least two sub-zones having a polarized response wherein adjacent sub-zones have orthogonal orientations.

16. The multi-spectral light-field device of claim 1, wherein the micro-lens array is arranged for focusing rays passing a single aperture position to a single sensor position.

17. The multi-spectral light-field device of claim 1, wherein the micro-lens array is arranged between a high-refractive index spacer and a low-refractive index spacer, where the refractive index difference higher than 0.2 so as to generate a refraction by the micro-lens array, and where the optical filter is arranged on the low-refractive index spacer.

18. The multi-spectral light-field device of claim 1, wherein each micro-lens has a square, circular or hexagonal basis.

19. The multi-spectral light-field device of claim 1, wherein the micro-lens array is placed in a square or hexagonal array.

20. The multi-spectral light-field device of claim 1, wherein the micro-lens array comprises a substrate, wherein on a surface of said substrate, there is an aperture array wherein an array of micro-lenses is placed on top of this aperture array.

21. The multi-spectral light-field device of claim 1, wherein the optical filter has an inhomogeneous filter transmission function that is changing along the filter's radial dimension.

22. The multi-spectral light-field device of claim 21, wherein the inhomogeneous filter transmission function fits a non-constant range of incidence angles along the filter's radial dimension set by the imaging component.

23. The multi-spectral light-field device of claim 21, wherein the filter transmission function is a step function.

24. The multi-spectral light-field device of claim 21, wherein the filter transmission function is realized by individual thicknesses of some of various layers of high- and low-index material, wherein the different layer thicknesses are coated subsequently.

25. The multi-spectral light-field device of claim 21, wherein the filter transmission function is a gradient function.

26. The multi-spectral light-field device of claim 21, wherein the filter transmission function is altered by changing the period of a subwavelength structure of the optical filter.

27. The multi-spectral light-field device of claim 1, wherein the optical filter is processed on a curved surface.

28. The multi-spectral light-field device of claim 27, wherein the curved surface is part of an imaging lens.

29. The multi-spectral light-field device of claim 1, comprising an image sensor in the image plane.

30. The multi-spectral light-field device of claim 29, wherein the micro-lens array is processed directly on top of the image sensor.

31. Imaging system comprising:
the multi-spectral light-field device of claim 1,
at least one reference device.

32. The imaging system of claim 31, wherein the reference device is a two-dimensional camera device, comprising an imaging lens, an aperture and an image sensor.

33. The imaging system of claim 32, wherein the imaging lens of said multi-spectral light-field device and of said two-dimensional camera device are identical.

34. The imaging system of claim 32, wherein the image sensor of the two-dimensional camera device is the same image sensor of the multi-spectral light-field device for compactness and in order to ensure temporal consistency.

35. The imaging system of claim 32, wherein in the beam path of the two-dimensional camera device there is the substrate of the optical filter and/or of the micro-lens array of the multi-spectral light-field device in order to reduce the packaging effort.

36. The imaging system of claim 31, wherein the reference device is a non-spectral light-field device.

37. The imaging system of claim 36, wherein in the beam path of the reference device there is the substrate of the optical filter and/or of the micro-lens array of the multi-spectral light-field device, devoid of one or more layers and/or one or more structures and with the micro lens-array, in order to achieve a non-spectral light-field image in the light-field section of the image sensor as a reference signal.

38. Object identification system comprising
the multi-spectral light-field device of claim 1,
a third machine-learning module connected to the multi-spectral light field device, and arranged for identifying the object based on its data collected by the multi-spectral light-field device.

39. The object identification system of claim 38, further comprising:
at least one reference device,
a first machine-learning module for identifying an object by its shape,
a second machine-learning module for identifying spectral properties of the object,
the third machine-learning module being arranged for evaluating the separate results of the first machine-learning module and the second machine-learning module, so as to identify the object and its properties.

40. The object identification system of claim 39, wherein the first machine-learning module, the second machine-learning module and the third machine-learning module are the same machine-learning module.
